(19) United States
(12) Patent Application Publication
(10) Pub. No.: US 2023/0311311 A1
(43) Pub. Date: Oct. 5, 2023

(54) ROBOT CONTROL DEVICE, ROBOT CONTROL METHOD, AND NON-TRANSITORY COMPUTER READABLE STORAGE MEDIUM STORING ROBOT CONTROL PROGRAM

(71) Applicant: SEIKO EPSON CORPORATION, Tokyo (JP)

(72) Inventors: Masaki MOTOYOSHI, AZUMINO-SHI (JP); Yuma SHIMURA, MATSUMOTO-SHI (JP)

(21) Appl. No.: 18/127,677

(22) Filed: Mar. 29, 2023

(30) Foreign Application Priority Data
Mar. 30, 2022 (JP) 2022-055406

(51) Int. Cl. B25J 9/16

(52) U.S. Cl. CPC B25J 9/163

(57) ABSTRACT

A robot control device including a control section configured to cause a robot to perform work, wherein the control section is configured to decide control parameters based on a table in which is defined a correspondence relationship between work contents of the work to be performed by the robot and level of the control parameters of the robot, the table includes, as the control parameters, a command followability that indicates followability of the robot to a position command and an operation end determination reference that indicates a reference for determining an end of an operation of the robot, and each of level of the command followability and level of the operation end determination reference are changeable.

The present application is based on, and claims priority from JP Application Serial Number 2022-055406, filed Mar. 30, 2022, the disclosure of which is hereby incorporated by reference herein in its entirety.

### BACKGROUND

### 1. Technical Field

The present disclosure relates to a robot control device, a robot control method, and a robot control program.

### 2. Related Art

An industrial robot needs to operate according to work of each operator. However, since work content varies depending on the operator, a parameter for operating the robot is generally set, as an initial value, to a general-purpose value that can be widely used for the entire work area (movable range of the robot). When the parameter is set to general-purpose parameter in this way, there is an advantage that the robot operation can be performed in the same manner in all the work areas, but on the other hand it is difficult to locally increase accuracy, for example, to increase accuracy of the robot operation in a specific work area. From this point of view, JP-A-2009-142903 discloses a robot control device capable of setting a dedicated parameter for a specific work area.

However, the control parameter required by the operator differs depending on the type of work performed by the robot, for example, whether priority is given to speed or vibration suppression. Therefore, in the robot control device, it is desirable to set the control parameter suited to the desire of the operator. It is difficult for the robot control device of JP-A-2009-142903 to deal with this point.

### SUMMARY

A robot control device according to the present disclosure is a robot control device including a control section configured to cause a robot to perform work, wherein the control section is configured to decide control parameters based on a table in which is defined a correspondence relationship between work contents of the work to be performed by the robot and level of the control parameters of the robot, the table includes, as the control parameters, a command followability that indicates followability of the robot to a position command and an operation end determination reference that indicates a reference for determining an end of an operation of the robot, and each of level of the command followability and level of the operation end determination reference are changeable.

A robot control method according to the present disclosure includes deciding control parameters based on a table in which is defined a correspondence relationship between work content of the work to be performed by the robot and a level of the control parameters of the robot, wherein the table includes, as the control parameters, a command followability that indicates followability of the robot to a position command and an operation end determination reference that indicates a reference for determining an end of an operation of the robot, and each of level of the command followability and level of the operation end determination reference are changeable.

A non-transitory computer-readable storage medium that stores a robot control program of the present disclosure, the program includes deciding control parameters based on a table in which is defined a correspondence relationship between work content of the work to be performed by the robot and a level of the control parameters of the robot, wherein the table includes, as the control parameters, a command followability that indicates followability of the robot to a position command and an operation end determination reference that indicates a reference for determining an end of an operation of the robot, and each of level of the command followability and level of the operation end determination reference are changeable.

### BRIEF DESCRIPTION OF THE DRAWINGS

FIG. 1 is a perspective view showing the overall configuration of a robot system according to a preferred embodiment.

FIG. 2 is a diagram showing a table.

FIG. 3 is a graph showing speed of control parameters.

FIG. 4 is a graph showing a command followability of the control parameters.

FIG. 5 is a graph showing the operation end determination reference of the control parameters.

FIG. 6 is a graph showing the operation end determination reference of the control parameters.

### DESCRIPTION OF EMBODIMENTS

Hereinafter, a robot control device, a robot control method, and a robot control program according to the disclosure will be described in detail based on preferred embodiments showing in the accompanying drawings.

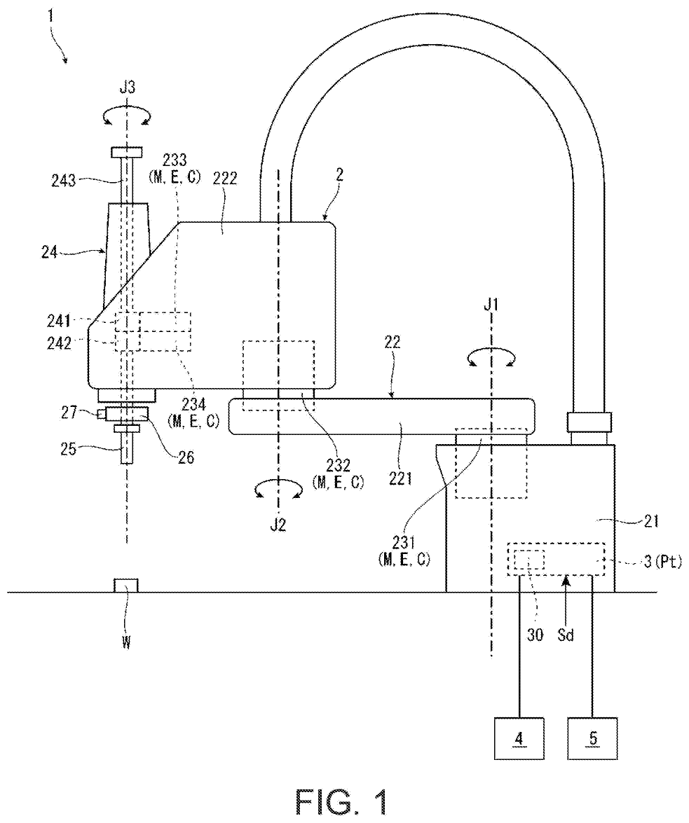

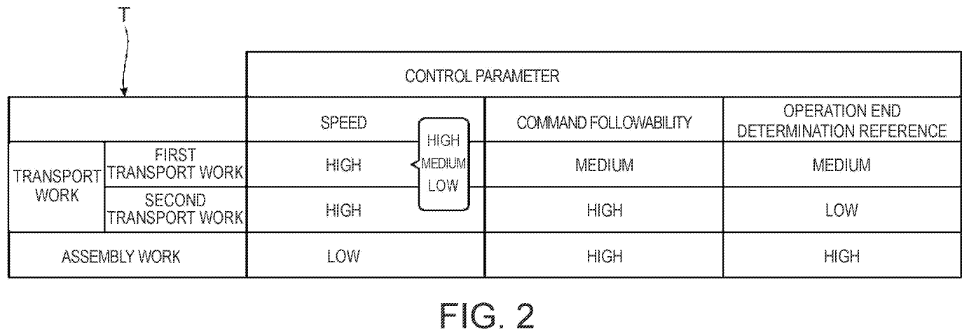

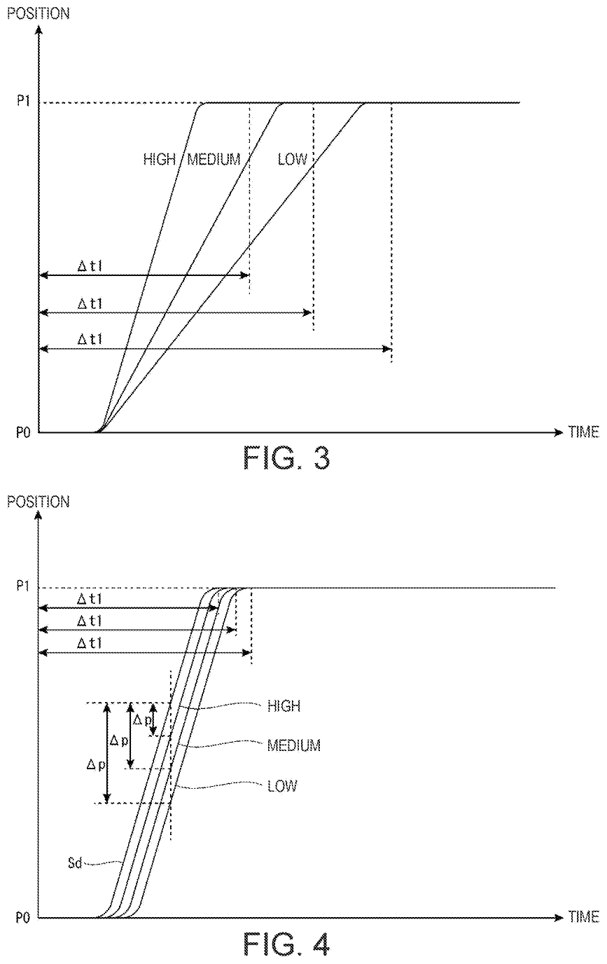

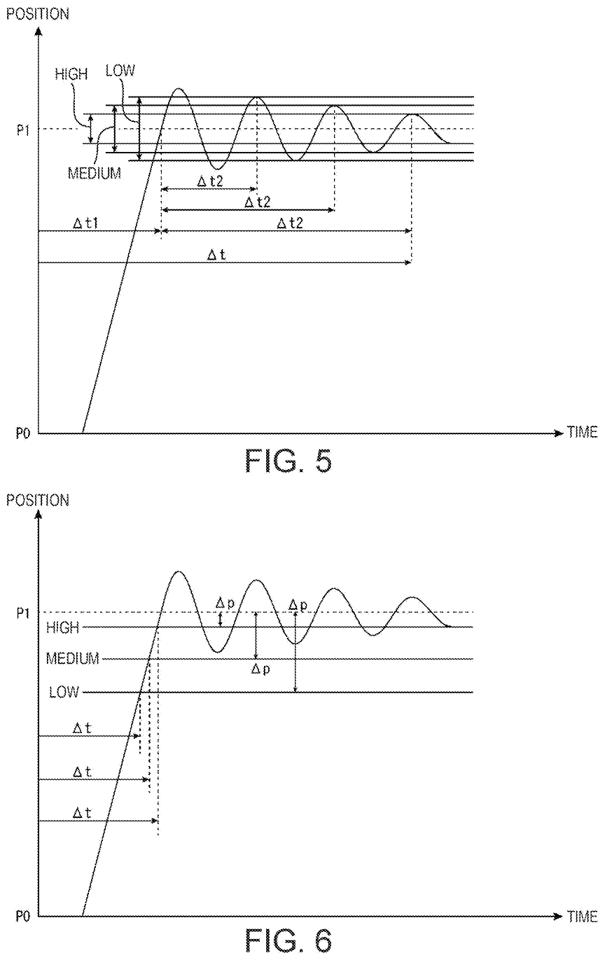

FIG. 1 is a perspective view showing the overall configuration of a robot system according to a preferred embodiment. FIG. 2 is a diagram showing a table. FIG. 3 is a graph showing speed of control parameters. FIG. 4 is a graph showing a command followability of the control parameters. FIG. 5 is a graph showing the operation end determination reference of the control parameters. FIG. 6 is a graph showing the operation end determination reference of the control parameters.

A robot system 1 shown in FIG. 1 includes a robot 2, a robot control device 3 that controls drive of the robot 2, and a display device 4 and an input device 5 that are connected to the robot control device 3.

Robot 2

The robot 2 is a horizontal articulated robot (scara robot), and is used in, for example, operations such as holding, transporting, assembling, and inspecting a work such as an electronic component. However, the use of the robot 2 is not particularly limited. Further, the robot 2 is not limited to the horizontal articulated robot, and may be, for example, a six axes vertical articulated robot.

The robot 2 includes a base 21 fixed to a floor surface and a robot arm 22 connected to the base 21. The robot arm 22 includes a first arm 221 that has a base end section connected to the base 21 and that is rotatable around a first axis J1 with respect to the base 21, and a second arm 222 that has a base end section connected to a tip end section of the first arm 221 and that is rotatable around a second axis J2 parallel to the first axis J1 with respect to the first arm 221. A working head 24 is provided at a tip end section of the second arm 222.

The working head 24 includes a spline nut 241 and a ball screw nut 242 that are coaxially disposed at the tip end section of the second arm 222, and a spline shaft 243 that is inserted through the spline nut 241 and the ball screw nut 242. The spline shaft 243 is rotatable with respect to the second arm 222 around a third axis J3, which is the center axis of the spline shaft 243, and can be raised and lowered in the direction along the third axis J3. The third axis J3 is parallel to the first axis J1 and the second axis J2.

A payload 26 for mounting an end effector 25 is provided at a lower end section of the spline shaft 243. The end effector 25 attached to the payload 26 is not particularly limited and may be appropriately selected depending on work contents, but in the present embodiment, a hand for sucking and holding the object is used.

Further, an inertial sensor 27 is disposed on the payload 26, and can detect acceleration and angular speed applied to the tip end of the robot arm 22.

In addition, a drive device 231 that rotates the first arm 221 around the first axis J1 with respect to the base 21 is provided in the base 21. In the second arm 222, there are provided a drive device 232 for rotating the second arm 222 around the second axis J2 with respect to the first arm 221, a drive device 233 for rotating the spline nut 241 to rotate the spline shaft 243 around the third axis J3, and a drive device 234 for rotating the ball screw nut 242 to raise and lower the spline shaft 243 in a direction along the third axis J3.

Each drive device 231, 232, 233, and 234 has a motor M as a drive source, a controller C for controlling the drive of the motor M, and an encoder E for detecting the amount of rotation of the motor M, and drives the motor M by servo control that feedbacks the output of the encoder E.

Robot Control Device 3

The robot control device 3 includes, for example, a control section 30 that independently controls the drive devices 231, 232, 233, and 234 and the drive of the end effector 25 based on a position command Sd from a host computer (not illustrated) and causes the robot 2 to perform a predetermined operation.

The robot control device 3 is configured by, for example, a computer, and includes a processor that processes information, a memory that is communicably connected to the processor, and an external interface that performs connection with an external device. A robot control program Pt which can be executed by the processor is stored in the memory, and the processor reads the robot control program Pt stored in the memory and executes the control method described below.

Here, in order to operate the robot 2, it is necessary to set in advance various control parameters necessary for controlling the robot 2, such as the movable range of the robot arm 22, the speed, the command followability, and the operation end determination reference. In the field of robots, it is common for manufacturers to appropriately set these control parameters at the time of shipment in consideration of safety, operability, and the like. However, the content of work to be performed by the robot 2 varies depending on each operator, and optimal control parameters also vary depending on the work content. Therefore, manufacturers generally set general-purpose control parameters as initial values so as to be widely applicable to various operations.

However, with the general-purpose control parameters, there is a possibility that the accuracy of work desired by the operator is not sufficient. Therefore, the robot control device 3 stores the control parameters as table T, and can change the control parameters in response to a request from the operator. Accordingly, it is possible to operate the robot 2 with the control parameters suitable for the request of the operator.

As shown in FIG. 2, table T includes, as work contents, a transport work for transporting an object W and an assembly work for assembling the object W. As described above, since the transport work and the assembly work are included as the work contents, most of the work performed by the robot 2 can be covered. Therefore, the robot control device 3 is highly convenient. Although the assembly work is not particularly limited, for example, work such as work of assembling the object W to other component by screwing, fitting, or the like, work of forming a hole in the object W by a drill or the like, or work of deforming the object W such as by embossing, bending, or the like.

Further, table T includes, as the transport work, a first transport work for transporting the object W that has less than a predetermined weight value and a second transport work for transporting the object W that has equal to or greater than the predetermined weight value. By this, it is possible to subdivide the transport work, and it becomes easy to set control parameters that are more specialized for the work content of the operator. The predetermined weight value can be set based on the characteristics of the robot 2, in particular, the transportable weight, and can be set to 50% of the transportable weight, for example.

In table T, the control parameters suitable for the work are set for each of the first and second transport work and assembly. Further, as the control parameters, the speed, the command followability, and the operation end determination reference are included, and each of them is selected from three levels of “high”, “medium”, and “low”. That is, in table T, correspondence relationships between the work content and levels of the control parameters are defined. However, the number of levels is not particularly limited, and may be two, four or more, or may be substantially stepless.

The speed included in the control parameters indicates the moving speed of the tip end of the robot arm 22, and as shown in FIG. 3, the higher that the level is, the faster that the speed of the robot arm 22 is. Therefore, the higher that the speed level is, the shorter that the time Δt1 is until the robot 2 reaches the target position P1 from the current position P0. The speed includes at least one of an absolute speed, an acceleration, a deceleration, an angular acceleration, and an angular deceleration.

The command followability indicates the followability of the robot 2 with respect to the position command Sd, and as shown in FIG. 4, the higher that the level is, the higher that followability is of the robot 2 to the position command Sd. Therefore, the higher that the level is of the command followability, the smaller that the difference Op is between the position based on the position command Sd during the movement to the target position P1 and the actual position, and the shorter the time Δt1 is until the robot arm 22 reaches the target position P1 from the current position P0.

The operation end determination reference indicates a reference for determining the end of one motion of the robot 2, and when the amplitude of the vibration remaining after the robot arm 22 reaches the target position P1 (hereinafter also referred to as “residual vibration”) becomes equal to or less than a predetermined value, then it is determined that the operation has ended. That is, as shown in FIG. 5, the higher that the level of the operation end determination reference is, the smaller that the amplitude is, so that the time Δt2, from when the robot arm 22 reaches the target position P1 to when the operation end determination is made, increases.

The actual position of the robot arm 22 and the detecting method of the residual vibration are not particularly limited. For example, detection can be performed based on the output of the inertial sensor 27. Further, it can be detected based on an output from the encoder E included in the drive devices 231, 232, 233, and 234. According to such a detection method, the actual position and residual vibration of the robot arm 22 can be easily and accurately detected.

As described above, the work time Δt that one operation of the robot 2 will take is determined by the sum of the time Δt1 from the current position P0 to arrival at the target position P1 and the time Δt2 from the arrival at the target position P1 to determination that the operation has ended. That is, Δt=Δt1+Δt2. It should be noted that the higher that the level is of the speed or that the level is of the command followability, the shorter that the time Δt1 tends to be because the speed of the robot 2 increases, but that, on the other hand, the longer that the time Δt2 tends to be because residual vibration increases. Conversely, the lower that the level is of the speed or of the command followability, the longer that the time Δt1 tends to be because the speed of the robot 2 decreases, but on the other hand, the shorter that the time Δt2 tends to be because the residual vibration decreases.

The operation end determination reference is not limited to the amplitudes of the residual vibrations described above, and the operation may be determined to have ended when the difference Δp between the target position P1 and the actual position becomes equal to or less than a predetermined value. That is, as shown in FIG. 6, the higher that the operation end determination reference level is, the smaller that the difference Δp is and the longer that the work time Δt is. Also by such a detection method, the actual position and the residual vibration of the robot arm 22 can be easily and accurately detected.

Depending on the work content, the work time Δt may be prioritized over the position accuracy, and in this case, it is desirable to increase the level of the speed or the command followability and to lower the level of the operation end determination reference. In addition, depending on the work content, the position accuracy may be prioritized over the work time Δt, and in this case, it is desirable to lower the level of the speed or the command followability and to increase the level of the operation end determination reference. In this way, preferred control parameters vary depending on the work content.

A high work speed is often required in the first transport work. Therefore, it is effective to increase the level of both the speed and of the command followability. Thus, the work time Δt can be shortened, and the transport work can be repeated many times at short time intervals. Further, in the first transport work, high positional accuracy is often required when gripping the object W and when placing the gripped object W. Therefore, it is effective that the level of the operation end determination reference also be high to some extent while avoiding that the working time Δt becomes excessively long. From the above, as shown in FIG. 2, the control parameters of the first transport work are set to “high” speed, “medium” command followability, and “medium” operation end determination reference as initial values.

The weight of the object W is heavier in the second transport work than in the first transport work, so high positional accuracy is often not required. Therefore, it is desirable to lower the level of the operation end determination reference and to shorten the work time Δt. In addition, since influence of the residual vibration is small, it is desirable to increase the levels of the speed and of the command followability, and aim to shorten the work time Δt. From the above, as shown in FIG. 2, the control parameters of the second transport work are set to “high” speed, “high” command followability, and “low” operation end determination reference as initial values.

In assembly work, a high command followability is often required because positional deviation directly leads to decrease in assembly accuracy. Therefore, it is effective to increase the level of command followability. As a result, the difference Δp between the position command Sd and the actual position becomes small, and the assembly work can be performed with excellent accuracy. Further, in the assembly work, it is effective to lower the speed level and to slowly operate the robot 2 in order to improve the assembly accuracy. Also, in the assembly work, for improving the assembly accuracy, it is effective to increase the level of the operation end determination reference and cause the robot 2 perform the next operation in a state of less residual vibration. From the above, as shown in FIG. 2, the control parameters of the assembly work are set to “low” speed, “high” command followability, and “high” operation end determination reference as initial values.

Table T has been described above. The robot control device 3 decides the control parameters based on such a table T. Typically, the control parameters are decided by comparing table T with the work content received from the operator. The robot control device 3 displays a graphic interface on a display device 4 such as a monitor, and an operator selects the work content via the graphic interface by input from the input device 5. When the work content is received from the operator via the graphic interface, the robot control device 3 sets the control parameters of the selected work content as the control parameters of the robot 2.

However, the method for deciding the control parameters is not particularly limited. For example, the robot control device 3 may select the work content based on the operation program created by the operator, and set the control parameters of the selected work content as the control parameters of the robot 2.

Regarding the transport work, for example, one of the first and second transport works may be selected based on the weight of the object W input by the operator via the graphic interface, and selected control parameters may be set as the control parameters for the robot 2. Alternatively, the robot 2 may be made to actually transport the object W, the weight of the object W may be measured based on the output from the inertial sensor 27 at that time, one of the first and second transport works may be selected from the measurement results, and the selected control parameters may be set as the control parameters for the robot 2.

According the robot control device 3 as described above, it is possible to set appropriate control parameters for each work content. Therefore, each work can be efficiently performed. In addition, since control parameters suitable for the work are automatically set by merely selecting the target work content or the work content close to the target work content from the plurality of work contents, which were set in advance, even an operator who has insufficient knowledge about robot control can easily set the control parameters suitable for the work content.

As described above, in the robot control device 3, desirable control parameters are set in advance for each of the first transport work, the second transport work, and the assembly work. However, some operators may want to finely adjust each item of the control parameters in order to realize desired work contents. Therefore, the robot control device 3 can change, in response to a request from the operator, each item of the control parameters, that is, the levels of the speed, the command followability, and the operation end determination reference, to any one of “high”, “medium”, or “low” for each work content stored in table T.

Although the changing method is not particularly limited, for example, the operator can use the input device 5 to request the level change of each item of the control parameters via the graphic interface displayed on the display device 4. The robot control device 3 changes the level of each item according to the request from the operator. According to such a configuration, it is possible to set control parameters that are more specialized for the work content of the operator. Therefore, it is possible to more reliably realize the work content required by the operator.

In particular, in the present embodiment, since each item of the control parameters are selected from the three levels of “high”, “medium”, and “low”, even an operator who has insufficient knowledge about robot control can intuitively and easily change the control parameters. The change of control parameters may be automatically performed by the robot control device 3 based on the work result of the robot 2.

The robot system 1 has been described above. The robot control device 3 described above, which is included in the robot system 1, has the control section 30 for causing the robot 2 to perform work.

The control section 30 decides the control parameters based on table T, in which is defined the correspondence relationship between the work content of the work to be performed by the robot 2 and the level of the control parameters of the robot 2.

Table T includes, as control parameters, the command followability that indicates followability of the robot 2 to the position command Sd and the operation end determination reference that indicates the reference for determining an end of an operation of the robot 2.

Then, both the level of the command followability and the level of the operation end determination reference are changeable.

In this way, each work included in table T can be performed with appropriate control parameters. In addition, since the level of the command followability and the level of the operation end determination reference can be changed, it is possible to set control parameters that are more specialized for the work content of the operator. Therefore, it is possible to more reliably realize the work content required by the operator.

As described above, table T further includes the speed of the robot 2 as a control parameter, and the level of the speed can be changed.

As a result, it is possible to set control parameters that are more specific for the work content of the operator. Therefore, it is possible to more reliably realize the work content required by the operator.

As described above, table T includes, as work contents, the transport work for transporting the object W and the assembly work for assembling the object W.

This makes it possible to cover most of the work performed by the robot 2. Therefore, the robot control device 3 is highly convenient.

As described above, table T further includes, as the transport work, the first transport work for transporting the object that has less than a predetermined weight value and a second transport work for transporting the object that has equal to or greater than the predetermined weight value.

By this, it is possible to subdivide the transport work, and it becomes easy to set control parameters that are more specialized for the work content of the operator. The predetermined weight value can be set based on the characteristics of the robot 2, in particular, the transportable weight, and can be set to 50% of the transportable weight, for example.

Further, as described above, the operation end determination reference is based on the difference Δp between the target position P1, which is based on the position command Sd, and the actual position, and the higher that the level of the operation end determination reference is, the smaller that the difference Δp is.

Thus, both the transport work and the assembly work can be performed with appropriate control parameters.

In addition, as described above, the operation end determination reference is based on the amplitude of the residual vibration, and the higher that the level of the operation end determination reference is, the smaller that the amplitude is.

Thus, both the transport work and the assembly work can be performed with appropriate control parameters.

In addition, as described above, in the robot control method, the control parameters are decided based on table T, in which is defined the correspondence relationship between the work content of the work to be performed by the robot 2 and the level of the control parameters of the robot 2.

Table T includes, as control parameters, the command followability that indicates followability of the robot 2 to the position command Sd and the operation end determination reference that indicates the reference for determining an end of an operation of the robot 2.

Then, both the level of the command followability and the level of the operation end determination reference are changeable.

In this way, each work included in table T can be performed with appropriate control parameters. In addition, since the level of the command followability and the level of the operation end determination reference can be changed, it is possible to set control parameters that are more specialized for the work content of the operator. Therefore, it is possible to more reliably realize the work content required by the operator.

In addition, as described above, in the robot control program Pt, the control parameters are decided based on table T, in which is defined the correspondence relationship between the work content of the work to be performed by the robot 2 and the level of the control parameters of the robot 2.

Table T includes, as control parameters, the command followability that indicates followability of the robot 2 to the position command Sd and the operation end determination reference that indicates the reference for determining an end of an operation of the robot 2.

Then, both the level of the command followability and the level of the operation end determination reference are changeable.

In this way, each work included in table T can be performed with appropriate control parameters. In addition, since the level of the command followability and the level of the operation end determination reference can be changed, it is possible to set control parameters that are more specialized for the work content of the operator. Therefore, it is possible to more reliably realize the work content required by the operator.

Although the robot control device, the robot control method, and the robot control program according to the present disclosure have been described above based on the illustrated embodiments, the present disclosure is not limited thereto, and the configuration of each section can be replaced with an arbitrary configuration that has the same function. In addition, other arbitrary components may be added to the present disclosure.

What is claimed is:

1. A robot control device comprising:
a processor configured to cause a robot to perform work, wherein
the processor is configured to decide control parameters based on a table in which is defined a correspondence relationship between work contents of the work to be performed by the robot and level of the control parameters of the robot, the table includes, as the control parameters, a command followability that indicates followability of the robot to a position command and an operation end determination reference that indicates a reference for determining an end of an operation of the robot, and
each of level of the command followability and level of the operation end determination reference are changeable.

2. The robot control device according to claim 1, wherein
the table further includes speed of the robot as one of the control parameters and
level of the speed is changeable.

3. The robot control device according to claim 1, wherein
the table includes, as work contents, transport work for transporting an object and assembly work for assembling the object.

4. The robot control device according to claim 3, wherein
the table further includes, as transport work, a first transport work for transporting the object that has less than a predetermined weight value and a second transport work for transporting the object that has equal to or greater than the predetermined weight value.

5. The robot control device according to claim 1, wherein
the operation end determination reference is based on a difference between a target position, which is based on the position command, and an actual position and
the higher that the level of the operation end determination reference is, the smaller that the difference is.

6. The robot control device according to claim 1, wherein
the operation end determination reference is based on an amplitude of a residual vibration and
the higher that the level of the operation end determination reference is, the smaller that the amplitude is.

7. A robot control method comprising:
deciding control parameters based on a table in which is defined a correspondence relationship between work content of the work to be performed by the robot and a level of the control parameters of the robot, wherein
the table includes, as the control parameters, a command followability that indicates followability of the robot to a position command and an operation end determination reference that indicates a reference for determining an end of an operation of the robot, and
each of level of the command followability and level of the operation end determination reference are changeable.

8. A non-transitory computer-readable storage medium that stores a robot control program, the program comprising:
deciding control parameters based on a table in which is defined a correspondence relationship between work content of the work to be performed by the robot and a level of the control parameters of the robot, wherein
the table includes, as the control parameters, a command followability that indicates followability of the robot to a position command and an operation end determination reference that indicates a reference for determining an end of an operation of the robot, and
each of level of the command followability and level of the operation end determination reference are changeable.
